(19) United States
(12) Patent Application Publication
(10) Pub. No.: US 2009/0303065 A1
(43) Pub. Date: Dec. 10, 2009

(54) Apparatus And Method For Detecting Transmission Belt Wear And Monitoring Belt Drive System Performance

(76) Inventor: Mats Lipowski, Toronto (CA)

Correspondence Address: WINSTON & STRAWN LLP;PATENT DEPARTMENT, 1700 K STREET, N.W., WASHINGTON, DC, 20006, US

(21) Appl. No.: 12/295,196

(22) PCT Filed: Mar. 28, 2007
(86) PCT No.: PCT/CA07/00496

§ 371 Date: Apr. 10, 2009

Related U.S. Application Data
(60) Provisional application No. 60/787,038, filed on Mar. 29, 2006.
(60) Provisional application No. 60/853,211, filed on Jan. 11, 2007.

(51) Int. Cl. G08B 21/00

(52) U.S. Cl. 340/679

(57) ABSTRACT

An apparatus and method to monitor endless belts and related belt drive systems by non-contact sensors for wear or an anomalous function, determining the state of belt drive system and detecting early stages of belt and system failure. A sensing unit featuring one or several independent sensor elements is placed near a belt of a polymer matrix with a fiber cord load bearing core to monitor several simultaneously occurring normal modes of operation. The sensor can determine soundness of the whole timing drive continuously by processing the collected signal and detecting structural damage. The collected data is processed by a microcontroller integrated with the sensor. The apparatus and method uses a non-contacting capacitor array having sensing element(s) connected to electronic circuitry that is adapted to sense the dynamic capacitance change coupled with electrocapacitive and piezoelectric effects exhibited by the belt. The sensor continuously monitors the belt during normal operation.

### BACKGROUND OF THE INVENTION

In the field of power transmission, belt drives are the preferred means to couple rotational elements. They are traditionally divided into two general categories: non-synchronous and synchronous belt drives. In vehicles, both categories are used extensively. Non-synchronous drives are the preferred means to drive accessories such as water pumps, air-conditioning compressors, power steering pumps and alternator units. Synchronous drives, commonly referred to as timing drives, have been the preferable means to drive overhead camshaft systems and are widely used in internal combustion engines wherever synchronicity of a driven component is necessary. An example of such a drive is shown in FIG. 1.

Timing belts are typically a composite of fiberglass, woven fabrics, rubber and other various polymers. All these materials exhibit piezoelectric properties: they are capable of generating electrical charges while they are being deformed. Under normal operating conditions, the belt is deformed by tension forces and by bending forces as the belt is running over sprockets and pulleys. These deformations generate charges. Due to the relatively high resistance of belt materials, charges exist long enough to be detected. The electric charges generated by piezoelectric effects are proportional to strain. This property has been successfully used in force transducers and accelerometers.

The invention herein described is adapted for both types of drives but is particularly suited to timing drives. Belts are more economical, less complex and more efficient than the other means in use, viz. chain or gear drives. The principal drawback with belts is the difficulty of determining their life span or the point in the vehicle's life at which the belt could potentially fail. To date, visual inspection is the only way to verify the state of a belt drive and its related components. However, this is a very cumbersome and impractical procedure. Timing drives, due to their vulnerability to contaminants, normally operate encased, and to remove the casing prior to visual inspection is usually a very labor-intensive process. Also, damage to the belt and other components is not always apparent to the eye, and a visual inspection may prove ineffectual. Further, failure of a belt causes the vehicle or drive to become inoperable and, due to the nature of modern combustion engines with their high compression ratios, a failing belt usually causes extensive damage to the engine affected as the failure entails de-synchronicity and a risk that the valve train and pistons collide.

Even though timing belts have evolved considerably with the usage of improved materials and enhanced tooth geometry, the structural progress has not solved the problem of life expectancy for whole timing drive systems. Uncertainty of belt drive life expectancy in conjunction with high repair cost and ensuing customer dissatisfaction have compelled the engine manufacturers to calculate with considerable safety margins in designing and using such drives. As a result, belts are manufactured considerably wider than necessary, and recommended mileages for a belt change are cautiously low. The uncertainty over the belt service life has forced engine manufacturers and timing drive designers to consider reverting back to chains rather than use belts. The trend in the marketplace towards maintenance-free engines has particularly strengthened such considerations. Still, engine manufacturers are very reluctant to go over to chains and have for many years tried to resolve this conundrum by any means possible.

Prior art shows an intense activity with many inventions purporting to address the issue. The numerous ideas presented do not resolve the problem and are largely not practical to industrialize. A number of solutions have not attracted investors because they are not sufficient to justify the additional cost or design challenges involved. This is a category of solutions that calls for design changes to the belt. U.S. Pat. No. 6,181,239 and U.S. Pat. No. 6,523,400 claim a solution where belt wear would be detected by breakage or changed inductance or capacitance of a belt-embedded wire or metallic structure. To anyone skilled in the art of making belts, such a solution is impractical. Embedding metallic structures in a belt would mean a tremendous departure from the manufacturing methodology and introduce a huge uncertainty as to the impact of such metallic structure on the overall durability of the belt. Belt manufacturers tend to have a very conservative approach to any design change, making the implementation of solutions of that type very dubious. Furthermore, the cost associated with such an undertaking would make the product overly expensive. Another shortcoming is that such a solution would only function with an OEM installed belt. In the automotive industry aftermarket, belts employed with a particular engine drive are frequently manufactured by several manufacturers. Often, belts used for service come from a different manufacturer than the belt installed by the OEM.

It is also recognized that inventions based on mechanical, photoelectric or on/off switch sensing devices, of which typical examples are U.S. Pat. No. 6,569,046, claiming use of an optical or mechanical switch to respond to side tracking of a worn belt, and U.S. Pat. No. 4,626,230, claiming use of such switches for detection of a failing tooth or cog, all come short of the target. These devices are vulnerable to contaminants and prone to give false alarms or become unreliable, as they stay dormant and are triggered into action only after the guarded belt has been damaged. Further, it is impossible to check such devices for function since the input required cannot be simulated. Because of the likelihood of a false alarm, they have to be calibrated to respond to severe upsets in the system, such as occur when the belt is already significantly failing. This gives little or no warning to the driver.

### THE SUMMARY OF THE INVENTION

The present invention for detecting wear of and damage to drive belts by non-contact means offers a significant improvement over those described in the prior art as it provides means to monitor performance of the drive by sensing any effects or inputs detrimental to the belt as well as any physical or structural damage to the belt. To anyone skilled in this field, it is apparent that belts used in timing systems shown in FIG. 1 are as durable as chains, provided that they operate under optimal conditions with no anomalous input values. The vast majority of cases when the belt fails prematurely is due to anomalies, such as after the belt has been subjected to faulty behavior of the components coupled to it, or contaminated by fluids like oil, coolant and other agents commonly used in engines and industrial machinery, or exposed to external dirt like dust, ice, water and stone chips penetrating through a leaky casing. By its nature, the invention can be used to monitor a drive belt against occurrence of any such anomalous effects. A further benefit obtains from a ready implementation of the invention into belt drives with no design changes required, as opposed to inventions described in the prior art. The invention offers a reliable system to determine the life span of a belt drive and enables the design staff to adopt a number of strategies on how to improve overall system quality.

In a new belt with uniform strength, piezoelectric charges are uniformly distributed. The new sensor is sensitive to the change in charge density and will therefore not have a large variation in output signal. When the belt is wearing from use, some sections of the belt become weaker and when loaded during engine operation will exhibit a larger deformation strain which, in turn, will cause a larger piezoelectric effect in this belt area and a higher local charge density. This new sensor senses the higher local charge resulting in increased signal amplitude. Thus, the larger the signal amplitude the weaker the belt is. The sensor also senses the change in capacitance that is the result of the dynamic change of dielectric properties of the belt.

The invention features a non-contact sensor that is coupled to an MPU (micro processing unit). The sensor operates by means of one or several capacitive sensing elements coupled into a circuit and designed to sense a change in permittivity or change in capacitance. The sensor also senses the electrostatic capacitance that results from the piezoelectric effect that the belt elicits as the belt strained structural material passes by the capacitive sensing elements during normal operation of the system. The piezoelectric properties of the belt generate a charge or quasi static electricity buildup in the belt during operation of the belt drive that is proportional to the deformation that the belt is subject to. The effect can be utilized as an indicator of belt weakening as a weakened belt section will have a larger deformation and therefore generate a higher charge which translates into a higher signal level from the sensor. The sensing elements are placed in such a fashion as to generate signal responses that correspond to key features of the belt and particular key modes the belt and belt drive exhibit during operation. Typical sensed modes are: basic belt signature, span vibration of natural and meshing frequencies, belt tooth derived instantaneous RPM and one per revolution signal events. Belt deterioration resulting in damage will typically start at one place on the belt, and the sensor will detect this and generate a one-per-belt revolution signal event, hereafter referred to as OPRSE.

Contamination will cause a permanent or semi-permanent change in the dielectric constant and/or the electrostatic capacitance and piezoelectric behavior of the belt which will be registered by any of the sensing elements and result in an overall change in the signal threshold. Incipient failure of any coupled components will cause a change in belt tension. The change in tension will cause a shift in the vibrational signature which the spans of the belt will re-exhibit during normal operation. Further, the torsional signature of the belt drive will also change. It is apparent to anyone skilled in the art of belt drives that the changes in signature can be directly linked to a quantitative increase or decrease in belt tension. The signal derived from the sensing circuitry can be processed by any number of signal processing methodologies. The analog based signal can be further conditioned and coupled to any device capable of data collection and signal analysis. However, the invention is best realized as a freestanding device where the analog signal is analyzed by a DSP (digital signal processing) algorithm executed by an in-the-sensor structure embedded MPU (micro processing unit). The resulting data is stored on board the sensor structure and, depending on the strategy of the end user, this data can be either further analyzed by algorithm in an external PLC (Programmable Logic Controller) or in the vehicle controller or it can be stored for transmission to a central data base.

This functionality would present the belt users (OEMs) with numerous benefits, such as: allowing for a nonlinear approach to service intervals, i.e., the vehicle would signal when the belt or other timing drive components need to be serviced vs. as heretofore, upon reaching a predetermined mileage (particularly beneficial to vehicles subjected to extreme duty cycles such as rescue, law enforcement or taxi vehicles). Detecting early signs of drive failures before severe damage or loss of function can occur gives big cost savings, especially if a failure would strike during a warranty period. Based on collected data, users could generate proactive responses, viz. issue service bulletins. Based on collected data, users could generate know-how on what constitutes the service life of a timing drive and how to best design drives. Belts could be made narrower, thereby saving millimeters in a space where such savings count. Employed as a marketing tool, the invention could reduce or eliminate the current mindset that belt drives are not reliable, giving the vehicle end users peace of mind. The above mentioned benefits are also directly applicable to industrial belt drive systems.

### DETAILED DESCRIPTION AND PREFERRED EMBODIMENTS

The invention is better understood from the following detailed description and preferred embodiments in conjunction with the following drawings.

### BRIEF DESCRIPTION OF THE DRAWINGS

FIG. 1 shows an elevational view of a belt drive with a suitable position of the sensing device;

FIG. 2 shows a sectional view of the sensing device and adjacent belt structure;

FIG. 3 shows a sectional view of a typical belt structure;

FIG. 4 shows a side view of a typical belt structure;

FIG. 5 shows an elevational view of a belt depicting a failure mode when a typical belt is showing exposed fiber cord and typical structural deficiencies;

FIG. 6 shows the side view of a belt depicting the failure of an individual belt tooth structure;

FIG. 7 shows an elevational view of a belt drive depicting the typical modes of vibration in the belt span between two components;

FIG. 8 shows a sectional view of a typical belt structure depicting the preferred perpendicular placement of a sensing element;

FIG. 9 shows a side view of a belt depicting the preferred perpendicular placement of a sensing element;

FIG. 10 shows a sectional view of a typical belt structure depicting the preferred parallel placement of a sensing element;

FIG. 11 shows a side view of a belt depicting the preferred parallel placement of a sensing element;

FIG. 12 shows a sectional view of a typical belt structure depicting the preferred horizontal placement of a sensing element;

FIG. 13 shows a side view of a belt depicting the preferred horizontal placement of a sensing element;

FIG. 14 is an elevational view showing a preferred construction method of a sensing element;

FIG. 15 is an elevational view showing a preferred construction method of a sensing element;

FIG. 16 is an elevational view showing a preferred construction method of a sensing element;

FIG. 17 is an elevational view showing a preferred construction method of a sensing element;

FIG. 18 is an elevational view showing a preferred sensing element;

FIG. 19 shows an elevation of a portion of a typical timing drive with an illustrated preferred embodiment of a complete sensing device;

FIG. 20 shows an auxiliary view of the same sensing device as in FIG. 19;

FIG. 21 shows a section view of a belt depicting a preferred position of the sensing elements/pickups and how the elements are connected to the electronic circuitry;

FIG. 22 shows a block diagram depicting the signal path through the major components of the sensing device and communication with devices external to the sensor;

FIG. 23 shows a signal generated at 55 Hz span vibration;

FIG. 24 shows a spectrum of the signal in FIG. 23;

FIG. 25 shows signal generated at 30 Hz span vibration;

FIG. 26 shows a spectrum of the signal in FIG. 25;

FIG. 27 shows a signal picking up a one-per-revolution event;

FIG. 28 shows a signal of belt teeth pulses;

FIG. 29 shows a side view of a belt depicting a cross section of a sensing element;

FIG. 30 shows a side view of a belt depicting the preferred perpendicular placement of two sensing elements utilizing signal cancellation; and

FIG. 31 shows a signal of belt teeth pulses and an effect of belt contamination.

### DESCRIPTION OF THE PREFERRED EMBODIMENTS

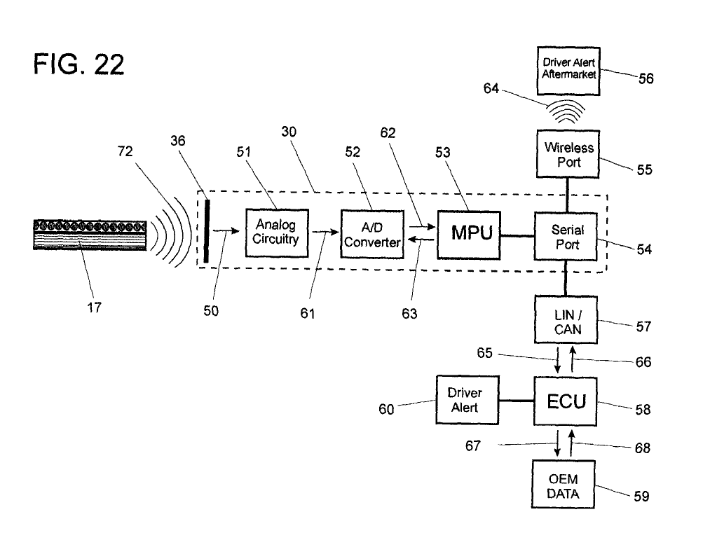

The invention features a sensing device and a signal analysis methodology particularly suitable to state the operational condition of a belt drive and to predict when the belt and/or its related components should be replaced to avoid a drive failure. Further, the invention features electronic circuitry 51 and sensing elements 36 as shown in FIG. 22 that operate by capacitive means coupled with the electrocapacitive and piezoelectric properties to collect signal data without touching the belt. The sensing elements 36 are capable of sensing the belt through a static structure, viz. a belt casing. The nature of the sensing makes it particularly well adapted to sense dynamic harmonic and transient events from the passing belt. The electronic circuitry can be realized in a number of ways by anyone skilled in the art of capacitive, electrocapacitive and piezoelectric sensing circuitry. The publication Capacitive Sensors Design and Applications, Larry K Baxter, IEEE, Piscataway, N.J., is an excellent source of examples of such circuitry. A novel approach to using MOS (metal oxide semiconductor) transistors described in that publication is preferable because of the ease with which elements can be integrated into mixed signal circuitry, but in terms of this invention, any capacitive sensing circuitry with suitable properties can be employed. This portion of the circuitry is referred to as analog circuitry 51. The sensing elements coupled into the analog circuitry are disposed around the targeted belt structure to best generate the desired signal input. The sensing elements 51 are comprised of two adjacently placed electrodes that create a defined capacitance and project a capacitive field. The electrodes are oriented toward the belt target in such a way that the belt changing dielectric properties will affect the capacitive field in such a fashion as to cause a change in the capacitance of the electrodes, which is sensed by the coupled analog circuitry 51. The sensing elements also sense the electrocapacitive charge buildup on the belt that is the result of the piezoelectric material properties of the belt material composite by means of inductive coupling.

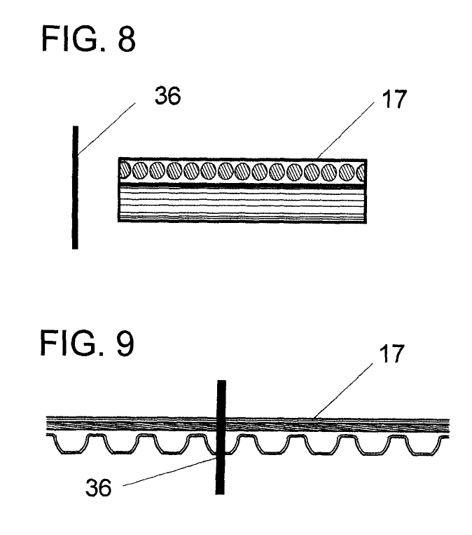

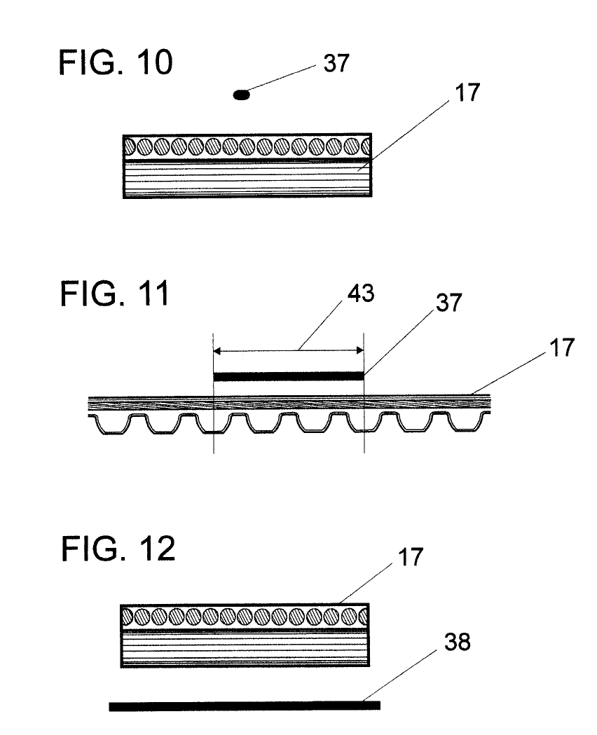

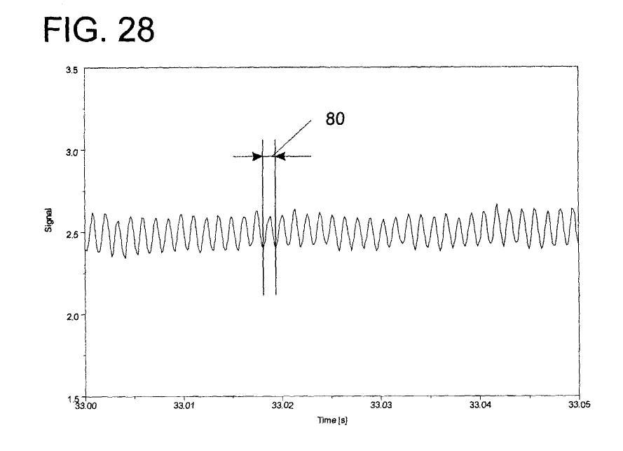

A sensing element 36 placed across the belt structure, as shown in FIGS. 8 and 9, will cause a signal response that is particular to the passing teeth structure 21. The signal response of the element is shown in FIG. 28 where distance 80 corresponds to the tooth pitch of the belt 17.

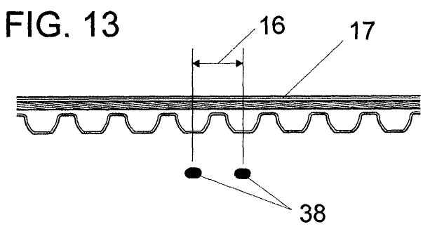

In terms of the invention, two or more sensing elements 36, 38 placed as shown in FIGS. 8, 9 and FIG. 13 spaced by a multiple of belt tooth pitch 16 will have the effect of increasing a signal response of the passing teeth.

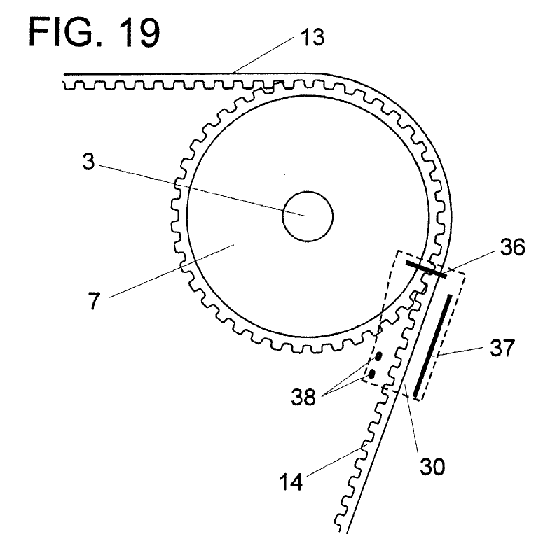

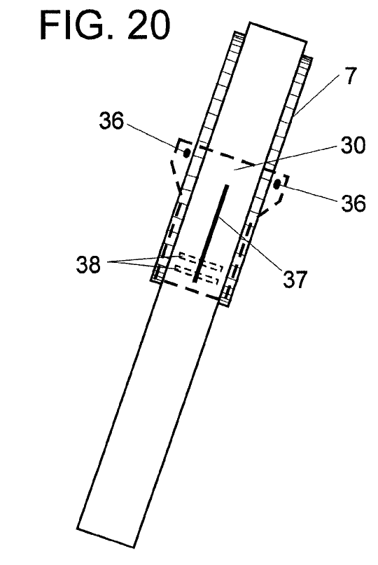

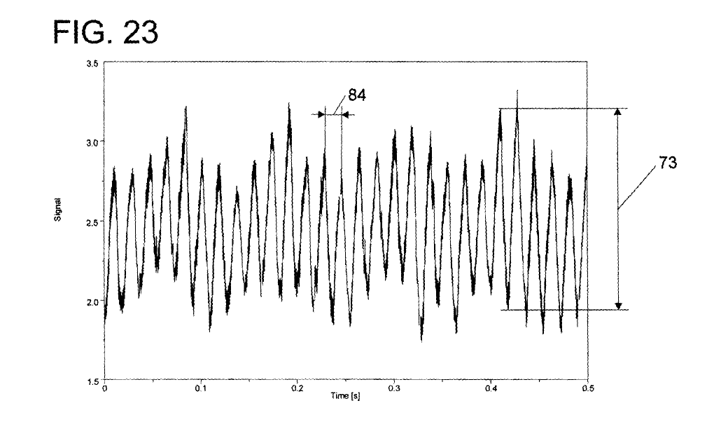

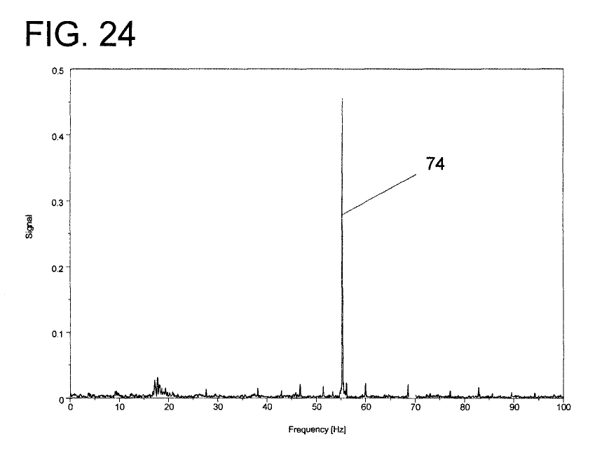

A sensing element 37, oriented lengthwise in the principal direction of belt movement as shown in FIGS. 19 and 20, will predominantly cause a signal response that is particular to the lateral movement 27 as shown in FIG. 7 of the belt span 14. The lateral movement normally is the result of natural or induced span vibration. FIG. 23 shows a typical signal response of a natural span vibration 27 shown in FIG. 7 with oscillation period 84 and amplitude 73. FIG. 24 shows a frequency spectrum of that signal where 74 denotes the natural frequency 71 of the belt span 14. A sensing element 37 having a length equivalent to three or more belt tooth pitches 16 is impervious to passing belt teeth and will therefore act as a filter for belt tooth generated meshing signals. The sensing element will only detect meshing related frequencies 70 if present in the lateral movement 26 of belt span 14.

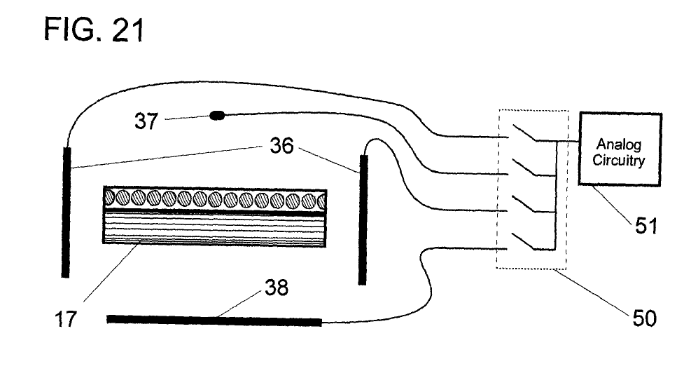

A sensor comprised of several sensing elements 36, 37 and 38, as shown in FIG. 21, is connected to the analog circuitry 51 using a multiplexing switch 50. The multiplexing switch is controlled by the MPU 53 shown in FIG. 22 and makes it possible to sample signal from each sensing element 36, 37 and 38, individually, collectively or in any combination required by the DSP strategy employed.

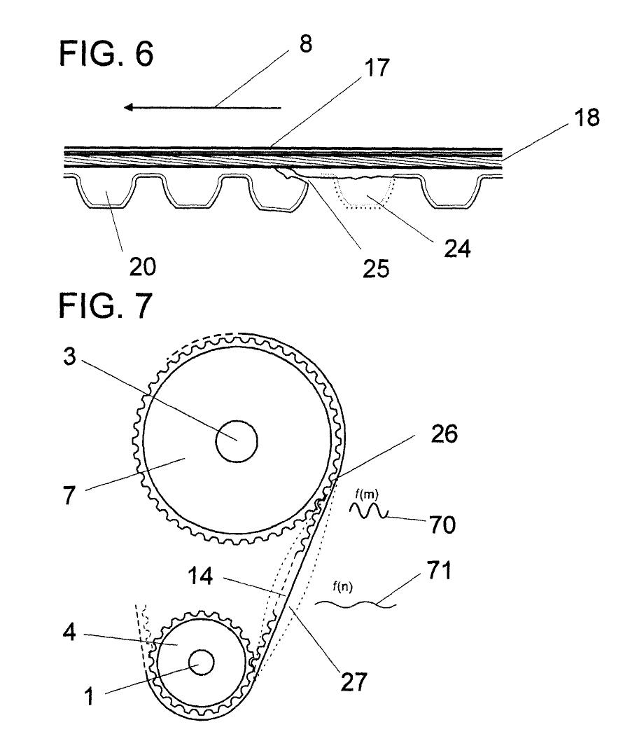

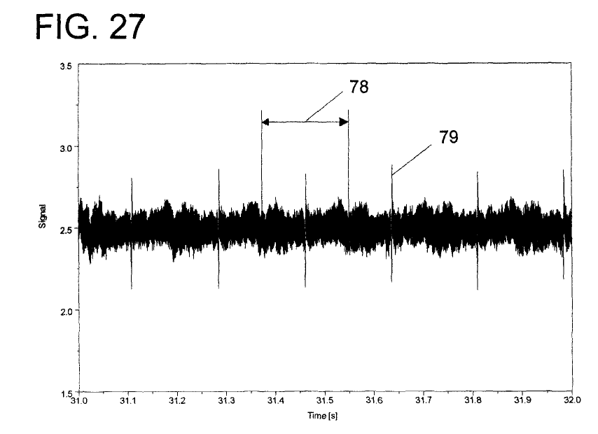

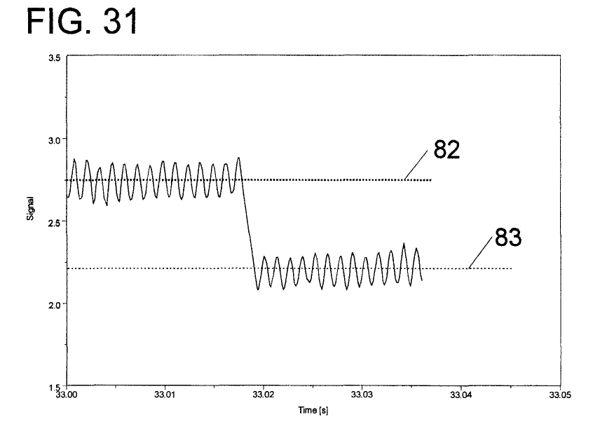

A couple of sensing elements 36 are positioned on the opposite or the same sides of the belt, as shown in FIG. 30, in such a distinctive arrangement that they are spaced by an increment of half belt pitch 45 and, consequently, one is facing a tooth tip while the other is facing a root. This sensing element configuration effects a significant reduction in signal response due to passing belt teeth 20 by the nature of signals 46, 47 canceling each other 81 as shown in FIG. 30 where diagram 81 illustrates this cancellation. This is particularly beneficial when the sensor is made to look for an OPRSE (one-per-revolution signal event) or when looking for internal structural damage viz weakening of the belt. OPRSE appears when damage due to structural deficiency or deterioration of the belt 17 is detected. In most cases, belt damage will commence at one point and, in the course of further operation, will spread, causing a total belt failure. An OPRSE is an indication that belt 17 is failing and should be promptly replaced. FIG. 5 shows two types of belt damage commonly indicated by an OPRSE: an incipient cord breakage 22 and a polymer deficiency 23. FIG. 6 shows damage to belt 17 due to deficient tooth structure 24 or cracked teeth 25. These types of damage will appear in a signal trace as a clearly discernable signal event. An example of said signal trace is shown in FIG. 27 where the signal peak 79 represents said OPRSE at one particular point on the belt, whereas distance 78 represents one full belt revolution past the sensing elements. The signal peaks 79 may be summed over a number of cycles before or after comparison with a threshold level to avoid stray signals and false alerts.

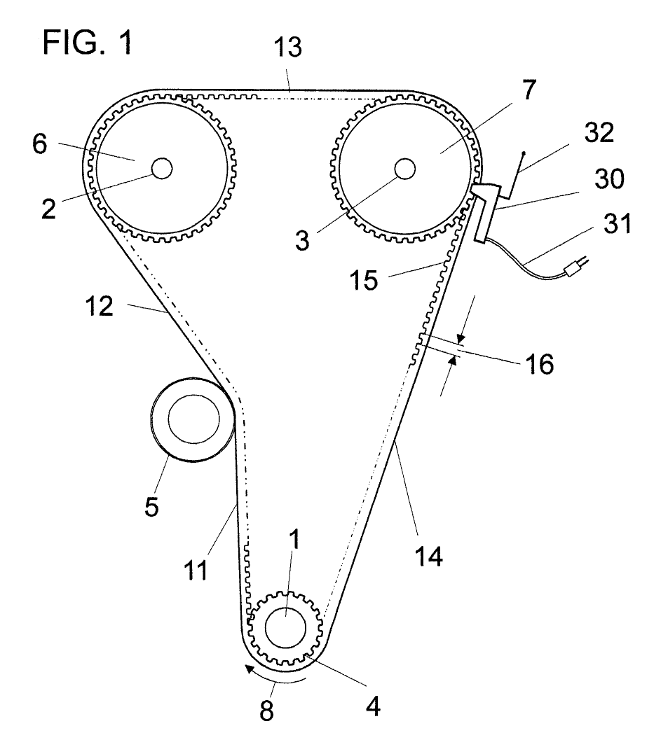

If a belt 17 used in a drive as shown in FIG. 1 becomes contaminated with fluids such as oil, engine coolant or any fluid contaminant that will leave a residue on the belt causing a sufficient change in its dielectric and/or electrocapacitive properties, the sensor assembly will detect the presence of the fluids and register a shift in overall signal threshold as shown in FIG. 31 where 82 denotes the measured signal level before contamination and 83 denotes the measured signal level after contamination.

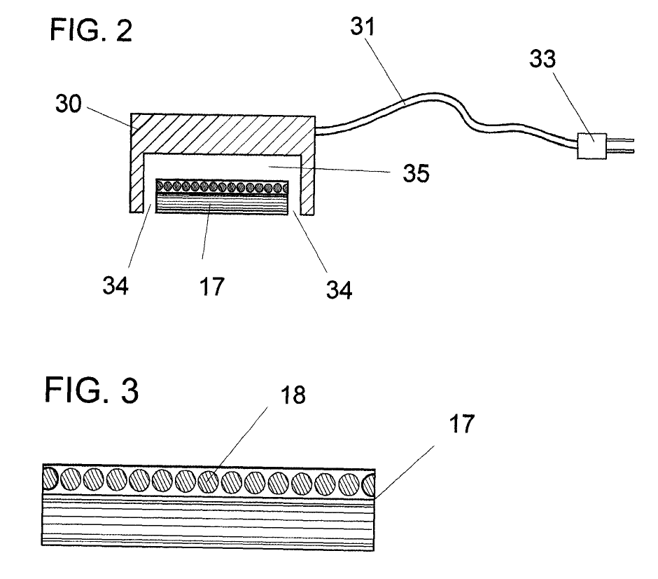

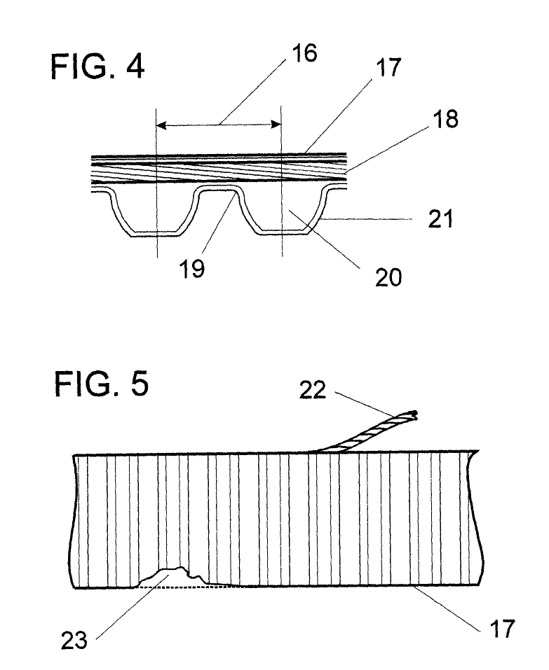

FIG. 1 shows one of the primary applications for the invention as a monitoring device for belt drives commonly used to maintain synchronicity of camshafts in internal combustion engines and commonly referred to as timing drives. In the belt drive, the new sensor 30 is placed adjacent to camshaft sprocket 7. In this position, the sensor 30 is best equipped to monitor the drive and detect any anomalous input to the belt 17 as well as to detect damage to the belt. As the sensor 30 operates by non-contacting means, it is spaced as shown in FIG. 2 with sufficient gaps 34 and 35 as to not interfere with the moving belt structure 17. The sensor 30 has all the sensing elements 36, 37, 38 and electronics embedded in its structure, as shown by the dashed line enclosure in FIG. 22, which enables the sensor to operate autonomously. The sensor 30 is connected to the vehicle engine controller and can function as a commonly practiced slave to the master vehicle engine controller 58 and communicate with the controller via wire 31 or wireless antenna 32. The signal path is as follows: sensing element 36 senses the belt 17 by means of the electric field 72. The element 36 is coupled to the analog circuitry 51 by multiplexing means 50 shown in FIG. 21. The circuitry generates an analog signal 61 that is converted to a digital data stream by A/D converter 52 and is stored in a micro processing unit MPU 53. The MPU 53 performs digital signal processing DSP by means of an embedded algorithm. A suitable DSP is well known to anyone skilled in the art of digital signal analysis.

The sensor assembly 30 may operate as a freestanding unit with an embedded battery power supply which enables operation independently of the vehicle power supply. This option is particularly suited for after market applications.

The electronics incorporated in the sensor assembly 30 communicate with the vehicle, either through a wire or wirelessly, using a serial automotive communication protocol, e.g., LIN (Local Interconnect Network) or CAN (Controller Area Network) 57, or derivate of such protocols (FIG. 22).

The electronics incorporated in the sensor assembly 30 have an embedded microcontroller MPU 53 which is pre-programmed with an algorithm capable of independent decision making based on the sensed signal if a failure of the belt or drive is imminent.

The sensor assembly 30 can be utilized as a system monitoring tool where the sensor can periodically, or upon request, transmit stored timing drive performance parameters, such as belt tension or camshaft torsional signature, to the vehicle controller ECU 58. The performance parameter can be transmitted wirelessly to the vehicle manufacturer if the vehicle is equipped with communication uplink or downloaded at the normally scheduled maintenance to a vehicle OEM 59 data base.

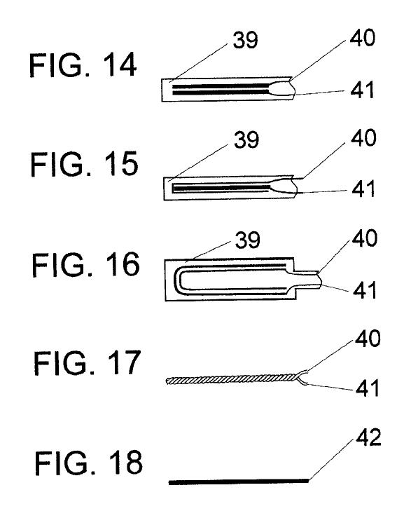

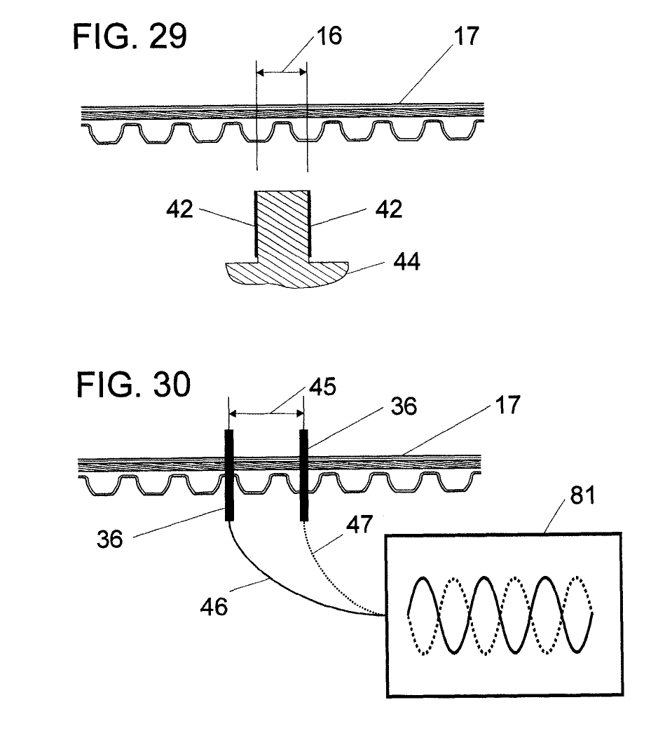

The sensing elements can be manufactured in many ways under the condition that desired sensing length and capacitance value is achieved in addition to tuning the surface area of the elements, which determines the sensing element's sensitivity to electrocapacitive effects. The basic sensing element is made up of two metallic structures that are spaced apart with a predisposed distance by a dielectric component. FIG. 14 shows a sensing element comprised of two parallel copper tracks 40 and 41 that have been etched on a PCB (printed circuit board) 39 using standard electronic industry circuit board manufacturing methods. FIG. 15 shows how copper track 40 surrounded by copper track 41 shaped as a U increases the sensing element capacitance while maintaining a small footprint. FIG. 16 shows two copper tracks 40 and 41 shaped as a horseshoe. FIG. 17 shows another way of making a sensing element by twisting two wires 40 and 41 each sheathed in a dielectric. The thickness of the wire sheath delimits the distance between the two wires that constitute the electrodes. FIG. 29 shows two metallic plates or strips 42 welded to the opposite sides of a dielectric material, where the distance between them is equivalent to half or full belt tooth pitch distance 16 of the target belt 17. The sensing element structure is suited to sense the passing belt tooth structure.

### Preferred Method Embodiments

Sensing elements 36, 37 and 38, connected to analog circuitry 51, output a continuously modulating analog alternating signal as shown in FIG. 28. The signal is converted to a binary signal and transferred to storage and calculation unit MPU 53 coupled to the analog circuitry 51. Based upon the signal an incorporated DSP algorithm calculates the instantaneous belt drive speed.

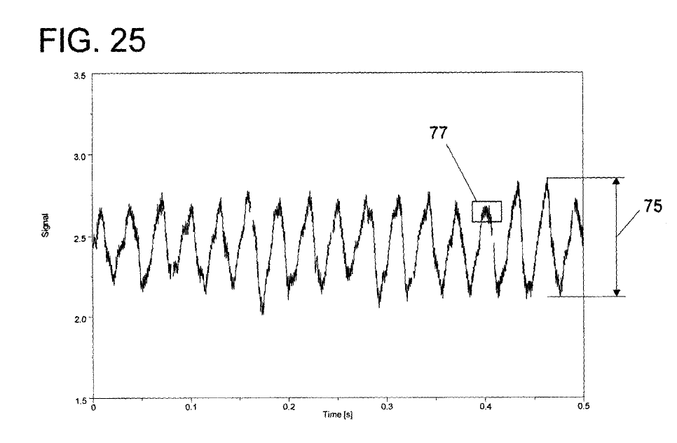

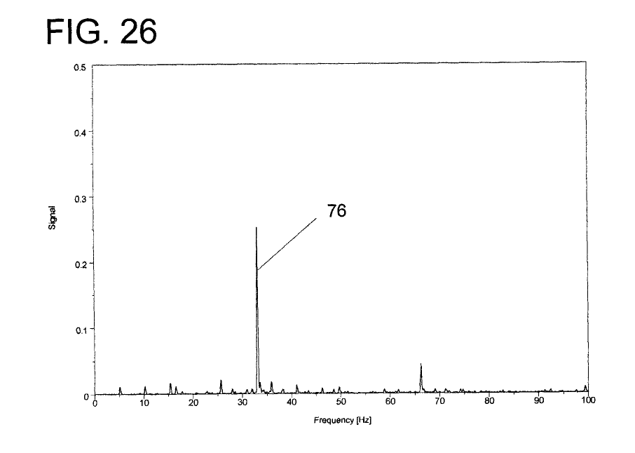

Sensing element 37 connected to analog circuitry 51 outputs a continuously modulating analog alternating signal as shown in FIGS. 23 and 25. The signal is converted to a binary signal and transferred to storage and calculation unit MPU 53 coupled to analog circuitry 51. Based upon said signal, MPU 53 with incorporated DSP algorithm calculates a natural frequency 74 of the particular belt span to which the sensing element is adjacent. To anyone skilled in the art of belt drives, the calculated frequency 74 can be correlated to the tension level in the belt span. A change in frequency 76 as shown in FIG. 26 is therefore indicative of a shift in belt tension. Monitoring the frequency provides a means to detect if the tension level in the belt has shifted outside predetermined operational thresholds. Further, if the signal shown in FIG. 25 exhibits additional frequency content, as in enclosed portion 77, the signal is indicative of an additionally induced belt span movement. The frequency component is commonly associated with belt and sprocket tooth engagement 26 and will be identical with measured signal frequency of the passing belt teeth 20. This phenomenon is aggravated by a mismatch in said engagement 26 as a result of incorrect belt tension applied to the belt structure. Another portion of the MPU 53 incorporated DSP algorithm is designed to monitor the occurrence and magnitude of said frequency and to compare said signal with predetermined operational limits. In the event the signal thresholds should surpass the operational limits, the MPU 53 embedded algorithm generates a defective belt drive alarm.

The signal generated by the passing teeth 20 is utilized in calculating (DSP) the torsional phasing angle of the camshaft. The data is compiled as the drive torsional signature and can be used to diagnose a change in operational conditions of the belt drive.

The MPU 53 embedded in the sensor 30 has an incorporated DSP algorithm that monitors the signals derived from the sensing elements 36, 37, 38 and 42 and determines if the targeted belt 17 or the belt drive exhibit operational behavior that is conducive to failure of the belt 17 or the belt drive. In the event of imminent failure, the algorithm generates a fault code that can be used to notify the driver/operator that the vehicle should be promptly serviced, or the fault code can be transmitted to the vehicle OEM or service provider for further action.

The sensor 30 is connected to the vehicle wire harness via a connector 33. The embedded algorithm communicates via the wire harness with vehicle ECU (engine control unit) using a digital network communication protocol LIN/CAN 57.

1.-19. (canceled)

20. A method of determining the physical and structural condition of a moving composite polymer and fiber belt under normal operating conditions comprising, sensing instantaneous dynamic dielectric and electrocapacitive properties of a belt portion as the belt portion moves by a capacitance sensing device to produce instantaneous dynamic capacitance signals, separating the instantaneous dynamic capacitance signals produced by at least one sensing element of the sensing device from any static capacitance signals simultaneously present, comparing the separated instantaneous dynamic capacitance signals with a threshold level of dynamic capacitance signal and, in response to a cyclic breach of the threshold level of dynamic capacitance signal by the separated instantaneous dynamic capacitance signals, actuating an output signal.

21. The method of claim 20, wherein the separated instantaneous dynamic capacitance signals that breach the threshold level of dynamic capacitance signal are summed over a predetermined time period prior to actuating the output signal.

22. The method of claim 20, wherein the output signal is an alert signal.

23. A capacitance sensing device comprising at least one sensing element adapted for location adjacent a normally moving composite polymer and fiber belt, said sensing element adapted to produce a cyclically changing electric signal in response to dynamic changes in the dielectric properties of the belt as the belt moves past the sensing device, and electric computational means including at least one analog-to-digital converter, a microprocessor and means to provide an output signal in response to a cyclic breach of a threshold level of dynamic change in belt dielectric properties.

24. The capacitance sensing device of claim 23, wherein a plurality of sensing elements are grouped above and to at least one side of the belt.

25. The capacitance sensing device of claim 23, wherein a plurality of sensing elements are spaced adjacent the belt at locations along the direction of movement of the belt.

26. The capacitance sensing device of claim 23, wherein the output signal is an alert signal.

27. A method of determining the physical condition of a moving composite polymer and fiber belt under normal operating conditions comprising, sensing the instantaneous dynamic electrostatic field of a belt portion as the belt portion moves by a sensing device to produce instantaneous dynamic signals, separating the instantaneous dynamic signals produced by at least one sensing element of the sensing device from any static signals simultaneously present, comparing the instantaneous dynamic signals with a threshold level of dynamic signal and, in response to a cyclic breach of the threshold level of dynamic signal by the instantaneous dynamic signals, actuating an output signal.

28. The method of claim 27, wherein the instantaneous dynamic signals that breach the threshold level of dynamic signal are summed over a predetermined time period prior to actuating the output signal.

29. The method of claim 27, wherein the output signal is an alert signal.

30. A sensing device comprising at least one sensing element adapted for location adjacent a normally moving composite polymer and fiber belt, said sensing element adapted to produce a cyclically changing electric signal in response to dynamic changes in the electrostatic field of the belt as the belt moves past the sensing device, and electric computational means, including at least one analog-to-digital converter, a microprocessor and means to provide an output signal in response to a cyclic breach of a threshold level of dynamic change in belt electrostatic field.

31. The sensing device of claim 30, wherein a plurality of sensing elements are grouped above and to at least one side of the belt.

32. The sensing device of claim 30, wherein a plurality of sensing elements are spaced adjacent the belt at locations along the direction of movement of the belt.

33. The sensing device of claim 30, wherein the output signal is an alert signal.

34. A method of determining the physical condition and deterioration of a moving composite polymer and fiber belt under normal operating conditions comprising, sensing the electrical charge generated by piezoelectric coupling present in a belt portion as the belt portion moves by a non-contact charge sensor whereby a signal is produced in response to the instantaneous belt portion charge density.

35. The method of claim 34, wherein the signal is proportional to the charge density.

36. The method of claim 34, wherein the signals produced over a selected time period that breach a specified threshold level are summed prior to actuating an output signal.

37. The method of claim 36, wherein the output signal is an alert signal.

38. A sensing device comprising at least three electroconductive sensing elements with at least one electroconductive sensing element aligned with the direction of movement of a belt, at least one electroconductive sensing element positioned to be perpendicular to the direction of movement of the belt and at least one electroconductive sensing element to be lying in a plane parallel to the direction of movement of the belt, wherein the sensing device is configured to at least partially surround a portion of the belt as it moves through the device.
